(19) United States
(12) Patent Application Publication
(10) Pub. No.: US 2008/0245260 A1
(43) Pub. Date: Oct. 9, 2008

(54) PARTICULAR NANOSTRUCTURED MATERIAL, AS PROTECTIVE COATING FOR METALLIC SURFACES

(75) Inventors: Elisa Campazzi, Boulogne Billancourt (FR); Emmanuelle Lancelle-Beltran, Bagneux (FR); Clement Sanchez, Bures Sur Yvette (FR)

Correspondence Address: OBLON, SPIVAK, MCCLELLAND MAIER & NEUSTADT, P.C., 1940 DUKE STREET, ALEXANDRIA, VA, 22314, US

(73) Assignees: EUROPEAN AERONAUTIC DEFENCE AND SPACE COMPANY, Paris (FR); Universite Pierre et Marie Curie, Paris Cedex (FR); Centre National De La Recherche, Paris (FR)

(21) Appl. No.: 12/098,054

(22) Filed: Apr. 4, 2008

(30) Foreign Application Priority Data
Apr. 6, 2007 (FR) 07 54375

(51) Int. Cl. C09D 5/08

(52) U.S. Cl. 106/14.41

(57) ABSTRACT

The invention relates to a novel nanostructured material comprising at least one nano-building block based on silica, alumina, zirconia, titanium oxide or cerium (IV) oxide, functionalized with at least two functionalizing agents of formula (1), (2) or (3):

Z₄₋ₓSi((R′)ₚ—F)ₓ (1)

Z_{4-x-y}(F′—(R′)ₚ)_{y}Si((R′)ₚ—F)ₓ (2)

Z_{n-ma-mb}(F′-L)ₘₐM(L-F)_{mb} , (3)

and its application in the aeronautics or aerospace field as a protective coating for metallic surfaces.

The present invention relates to nanostructured materials as constituents of protective coatings for metallic surfaces, in particular for aeronautic and aerospace applications, and to their preparation methods.

In the aeronautics field, protection against corrosion is generally provided by surface treatments based on chromium VI, for example, using a chromium anodizing method, or conversion coating.

However, chromium VI has been found to be toxic, carcinogenic and dangerous for the environment. In time its use will be prohibited.

There is therefore a need to find another system that provides protection, for example, against corrosion but also against scratches or other things, which is at least as high-performance as those that exist.

Hybrid organic/inorganic materials prepared by a sol-gel process have already been envisaged in the art.

For example, document US 2003/024432 describes a coating having anti-corrosive properties, prepared by a sol-gel process starting from an organometallic salt such as an alkoxy zirconium, from an organosilane and from one or more compounds bearing a borate, zinc or phosphate functional group, in the presence of an organic catalyst such as acetic acid.

Documents U.S. Pat. No. 6,261,638 and EP 1 097 259 themselves describe methods for preventing metal corrosion, comprising the application of a treatment solution based on polyfunctional silanes and on difunctional silanes that comprise several sulphur atoms in their chain, respectively.

However, these materials have the drawback of not being microstructured or nanostructured, that is to say that the distribution of the organic and inorganic domains in the material cannot be controlled at the micrometric or nanometric level. This random distribution may result in properties that are unreproducible from one material to another.

An advantage of the sol-gel process consists in constructing a three-dimensional network from initial precursors under conditions referred to as mild conditions, that is to say at a temperature below 200° C. and in a water or water/solvent medium that is less harmful for the environment than those used for conventional surface treatments.

The initial precursors generally used in said sol-gel process are metal alkoxides comprising one or more hydrolysable groups. As examples of metal alkoxides, mention may especially be made of silicon or zirconium alkoxides, alone or as a mixture.

The article “The self-assembled nanophase particle (SNAP) process: a nanoscience approach to coatings”, M. S. Donley et al, Progress in Organic Coatings, 47, 401-415, 2003, describes coatings made from an amorphous material, obtained under mild conditions, starting from an aqueous solution comprising tetramethoxysilane and glycidopropyltrimethoxysilane. A corrosion inhibitor is then introduced into the material.

U.S. Pat. No. 6,929,826 describes a method for treating metallic surfaces starting from an aqueous composition comprising an alkoxysilane, an epoxyalkoxysilane and water. This method comprises, in particular, the steps of mixing the ingredients of the composition, ageing said composition, addition of a crosslinking agent, a surfactant and optionally water, then application of the final composition to a metallic substrate and drying of said substrate.

The Applicant has surprisingly discovered that control of the structure at the nanoscale level makes it possible to obtain novel macroscopic properties which are not only the sum of the properties of each of the components, such as mechanical strength, film thickness and quality, density, colouring and hydrophobic character that can be adjusted at will, but are actually novel properties. They result from the synergy of these components at the nanoscale level. Moreover, this control of the structure at the nanoscale level results in a reproducibility of the properties.

This control is achieved due to the nanostructured materials.

The expression “nanostructured materials” is understood to mean materials whose structure is controlled at the nanoscale level. This structure may be verified, in particular, by small-angle X-ray scattering and X-ray diffraction, transmission electron microscopy (TEM) or atomic force microscopy (AFM).

Such materials are known from the article “Designed hybrid organic-inorganic nanocomposites from functional nanobuilding blocks” by C. Sanchez et al., Chem. Mater., 2001, 13, 3061-3083, and are synthesized from well-defined, preferably pre- or post-functionalized, nanoscale-sized building blocks (or nano-building blocks (NBBs)) and from a polymer or hybrid organic/inorganic resin.

One part of these materials, such as the matrix obtained by the sol/gel process is amorphous, whereas the other part is formed from nanoscale-sized crystalline domains.

These materials may comprise various functionalities that make it possible to give a substrate (or surface), especially an aluminium or titanium alloy for example, protection against corrosion, scratch resistance, good mechanical strength and/or colouring while ensuring good adhesion to the metallic substrate.

Moreover, these materials may allow the coexistence of several different functionalities that normally do not coexist, and may be applied by any conventional technique such as, for example, by dipping in a bath, depositing on a substrate by spin, spray or laminar-flow coating and depositing with a brush. The individual components may be formed so as to have a shelf life that is compatible with industrial cycles, for example greater than or equal to 12 months, and may be mixed just before their application. Their formulation has the additional advantage of using components that are compatible with environmental regulations, and especially of being predominantly in an aqueous medium.

One subject of the present invention is novel nanostructured materials that make it possible to impart better properties such as protection against corrosion, scratch resistance, good mechanical strength and/or colouring while ensuring good adhesion to a metallic substrate.

The nanostructured materials according to the invention comprise at least one nano-building block based on silica, alumina, zirconia, titanium oxide or cerium (IV) oxide, functionalized with at least two functionalizing agents of formula (1), (2) or (3):

Z₄₋ₓSi((R′)ₚ—F)ₓ (1)

Z_{4-x-y}(F′—(R′)ₚ)_{y}Si((R′)ₚ—F)ₓ (2)

Z_{n-ma-mb}(F′-L)ₘₐM(L-F)_{mb} (3)

in which:
each Z represents, independently of one another, a halogen atom, such as F, Cl, Br or I, preferably Cl or Br, or an —OR group;
R represents an alkyl, preferably C₁₋₄ alkyl, such as methyl, ethyl, n-propyl, i-propyl, n-butyl, s-butyl or t-butyl, preferably methyl or ethyl group;
x and y are integers ranging from 1 to 3 on condition that 4−x≧1 for the formula (1) and 4−x−y≧0 for the formula (2);
each R′ represents, independently of one another, an organic spacer group chosen from alkylene, preferably C₁₋₄ alkylene, for example, methylene, ethylene, propylene or butylene groups; alkenylene, especially C₂₋₄ alkenylene, such as vinylene, 1-propenylene, and butenylene groups; and C₆₋₁₀ arylene, such as phenylene and naphthylene groups;
p is equal to 0 or 1;
each F is chosen from alkyl groups, especially C₁₋₄ alkyl groups, for example, methyl, ethyl, propyl or butyl groups; alkenyl groups, in particular C₂₋₄ alkenyl groups, such as vinyl, 1-propenyl, 2-propenyl and butenyl groups; alkynyl groups, in particular C₂₋₄ alkynyl groups, such as acetylenyl and propargyl groups; aryl groups, in particular C₆₋₁₀ aryl groups, such as phenyl and naphthyl groups; methacryl or methacryloxy(C₁₋₁₀ alkyl), such as methacryloxypropyl, groups; epoxyalkyl or epoxyalkoxyalkyl groups in which the alkyl group is linear, branched or cyclic, and is a C₁₋₁₀ alkyl group, and the alkoxy group comprises from 1 to 10 carbon atoms, such as glycidyl and glycidyloxy (C₁₋₁₀ alkyl) groups; C₂₋₁₀ haloalkyl, such as chloropropyl, groups; C₂₋₁₀ perhaloalkyl, such as perfluoropropyl, groups; C₂₋₁₀ mercaptoalkyl, such as mercaptopropyl, groups; C₂₋₁₀ aminoalkyl, such as 3-aminopropyl, groups; amino(C₂₋₁₀ alkyl)amino(C₂₋₁₀ alkyl), such as 3-[(2-aminoethyl)amino]propyl, groups; di(C₂₋₁₀ alkylene)triamino(C₂₋₁₀ alkyl), such as 3-[diethylenetriamino]propyl, groups and imidazolyl(C₂₋₁₀ alkyl) groups;
each F′ and L are, each one, a monodentate or polydentate complexing ligand, preferably a polydentate complexing ligand, for example a carboxylic acid such as acetic acid, a β-diketone such as acetylacetone, a β-keto ester such as methyl acetoacetate, an α- or β-hydroxy acid such as lactic acid, an amino acid such as alanine, a polyamine such as (3-trimethoxysilylpropyl)diethylenetriamine (or DETA), phosphonic acid and a phosphonate;
M represents Al(III), Ce(III), Ce(IV), Zr(IV), Ti(IV), Sn(IV), Nb(V), V(V), Ta(V), Hf(V), preferably Al(III), Ce(III), Ce(IV), Zr(IV) or Ti(IV), or a rare earth such as Y(III), La(III) and Eu(III), the number between brackets being the valency of the M atom;
n represents the coordination state of the M atom;
m represents the number of coordination bonds between the chelating agent L and the metal M;
a and b are integers such that ma+mb≦n.

In the formulae (1) and (2), each ((R′)ₚ—F) and ((R′)ₚ—F′) are non-hydrolysable groups, F being a functional group that preferably has an affinity for an optional organic or hybrid matrix, and F′ being a functional group that preferably has an affinity for the surface of the nano-building blocks.

In the formula (3), (L-F) and (L-F′) each represent a group that complexes the metal M via L and respectively have a function F that preferably has an affinity for an optional organic or hybrid matrix, and a functional group F′ that preferably has an affinity for the surface of the nano-building blocks.

The nano-building block or blocks may be in cluster form or in the form of nanoparticles, preferably nanoparticles having a size ranging from 2 to 100 nm, better still from 2 to 50 nm and even better from 2 to 20 nm, the diameter of these nanoparticles possibly being measured by small-angle X-ray scattering and X-ray diffraction, transmission electron microscopy (TEM) or light scattering.

These nano-building blocks are mainly based on at least one metal oxide, the metal oxide being chosen, for example, from aluminium, cerium IV, silicon, zirconium and titanium oxides. Several methods of synthesis may be used to prepare them.

A first method consists in synthesizing them from metal salts, by precipitation. Complexing agents may be introduced into the reaction medium in order to control the size of the nano-building blocks formed and ensure their dispersion in the solvent by functionalizing 80 to 100% of the surface of the nanoblocks with monodentate or polydentate complexing agents, such as for example, carboxylic acid, β-diketone, β-keto ester, α- or β-hydroxy acid, phosphonate, polyamine and amino acid. The weight ratio between the mineral and organic components is especially between 20 and 95%.

The nano-building blocks may also be obtained from at least one alkoxide or halide of silicon, aluminium, zirconium, titanium or cerium (IV), via hydrolytic or non-hydrolytic processes. In the case of a hydrolytic process, the controlled hydrolysis is carried out of at least one alkoxide or halide of silicon, aluminium, zirconium, titanium or cerium (IV) of general formula:

M₁(Z₁)ₙ₁ (4),

(R₁′)ₓ₁M₁(Z₁)ₙ₁₋ₓ₁ (5),

(L₁^{m1})ₓ₁M₁(Z₁)ₙ₁₋ₘ₁ₓ₁ (6), or

(R₁O)₃Si—R₂—Si(OR₁)₃ (7),

formulae (4), (5), (6) and (7) in which:
M₁ represents Al(III), Ce(IV), Si(IV), Zr(IV) or Ti(IV), the number between brackets being the valency of the M₁ atom;
n₁ represents the valency of the M₁ atom;
x₁ is an integer ranging from 1 to n₁−1;
Z₁ represents a halogen atom or —OR₁;
R₁ represents an alkyl group, preferably comprising 1 to 4 carbon atoms;
R₁′ represents a non-hydrolysable group chosen from alkyl groups, especially C₁₋₄ alkyl groups, alkenyl groups, in particular C₂₋₄ alkenyl groups, alkynyl groups, in particular C₂₋₄ alkynyl groups, aryl groups, in particular C₆₋₁₀ aryl groups, methacryl or methacryloxy(C₁₋₁₀ alkyl) groups, epoxyalkyl or epoxyalkoxyalkyl groups in which the alkyl group is linear, branched or cyclic, and is a C₁₋₁₀ alkyl group, and the alkoxy group comprises from 1 to 10 carbon atoms;
L₁ is a monodentate or polydentate complexing ligand, preferably a polydentate complexing ligand;
m₁ represents the degree of hydroxylation of the ligand L₁; and
R₂ represents a divalent non-hydrolysable group chosen from alkylene groups, preferably C₁₋₄ alkylene groups, alkenylene groups, in particular C₂₋₄ alkenylene groups, alkynylene groups, in particular C₂₋₄ alkynylene groups, arylene groups, in particular C₆₋₁₀ arylene groups, methacryl and methacryloxy(C₁₋₁₀ alkyl) groups, epoxyalkyl or epoxyalkoxyalkyl groups in which the alkyl group is linear, branched or cyclic, and is a C₁₋₁₀ alkyl group, and the alkoxy group comprises from 1 to 10 carbon atoms.

Preferably, R₁ represents a methyl or ethyl group; R₁′ represents a non-hydrolysable group chosen from methyl, ethyl, propyl, butyl, vinyl, 1-propenyl, 2-propenyl, butenyl, acetylenyl, propargyl, phenyl, naphthyl, methacryl, methacryloxypropyl, glycidyl and glycidyloxy(C₁₋₁₀ alkyl) groups; and L₁ is a complexing ligand chosen from carboxylic acids, β-diketones, β-keto esters, α- and β-hydroxy acids, amino acids and phosphonates.

The expression “controlled hydrolysis” is understood to mean a limitation of the growth of species formed by control of the amount of water introduced into the medium and optionally by introducing a complexing agent for the central metal atom, this being in order to reduce the reactivity of the precursors.

The nano-building blocks are preferably in the form of amorphous or crystalline nanoparticles. Their functionalization is carried out either directly during their synthesis, or in the course of a second step following their synthesis, in the presence of a functionalizing agent such as defined above, and preferably in the course of a second step. These are referred to as pre- or post-functionalization respectively.

According to the invention, the degree of functionalization is preferably greater than 50%, better still greater than 80%.

The nanostructured materials according to the invention, such as defined above, may comprise, in addition, a polymer or hybrid inorganic/organic matrix, preferably a hybrid sol/gel type matrix.

Once the nano-building blocks are synthesized and functionalized, they may be introduced into the said matrix. This matrix will serve as a connector, owing to which the building blocks will form a three-dimensional network.

The hybrid inorganic/organic matrices are typically obtained by polycondensation of at least one metal alkoxide or metal halide, in the presence of a solvent, and optionally a catalyst. The metal alkoxides or metal halides used are preferably chosen from those having the general formulae:

M′Z′_{n′} (8)

R″_{x′}M′Z′_{n′-x′} (9)

L′_{m′x′}M′Z′_{m′x′} (10)

Z′_{n′-1}M′—R″′-M Z′_{n′-1} (11)

in which:

n′ represents the valency of the M′ metal atom, preferably 3, 4 or 5;

x′ is an integer ranging from 1 to n′−1;

M′ represents a metal atom of valency III such as Al, of valency IV such as Si, Ce, Zr and Ti, or of valency V such as Nb. Preferably, M′ is silicon (n′=4), cerium (n′=4) or zirconium (n′=4), and more preferably still silicon.

Z′ represents a hydrolysable group chosen from halogen atoms, for example F, Cl, Br and I, preferably Cl and Br; alkoxy groups, preferably C₁₋₄ alkoxy groups, such as methoxy, ethoxy, n-propoxy, i-propoxy and butoxy groups; aryloxy groups, in particular C₆₋₁₀ aryloxy groups, such as phenoxy groups; acyloxy groups, in particular C₁₋₄ acyloxy groups, such as acetoxy and propionyloxy groups; and C₁₋₁₀ alkylcarbonyl groups, such as an acetyl group. Preferably, Z′ represents an alkoxy group, and more particularly an ethoxy or methoxy group.

R″ represents a monovalent non-hydrolysable group chosen from alkyl groups, preferably C₁₋₄ alkyl groups, for example methyl, ethyl, propyl and butyl groups; alkenyl groups, in particular C₂₋₄ alkenyl groups, such as vinyl, 1-propenyl, 2-propenyl and butenyl groups; alkynyl groups, in particular C₂₋₄ alkynyl groups, such as acetylenyl and propargyl groups; aryl groups, in particular C₆₋₁₀ aryl groups, such as phenyl and naphthyl groups; methacryl or methacryloxy(C₁₋₁₀ alkyl) groups, such as a methacryloxy propyl group; epoxyalkyl or epoxyalkoxyalkyl groups in which the alkyl group is linear, branched or cyclic, and is a C₁₋₁₀ alkyl group, and the alkoxy group comprises from 1 to 10 carbon atoms, such as glycidyl and glycidyloxy(C₁₋₁₀ alkyl) groups. R″ preferably represents a methyl group or a glycidyloxy(C₁₋₁₀ alkyl) group such as a glycidyloxypropyl group;

R′″ represents a divalent non-hydrolysable group chosen from alkylene groups, preferably C₁₋₄ alkylene groups, for example methylene, ethylene, propylene and butylene groups; alkenylene groups, in particular C₂₋₄ alkenylene groups, such as vinylene, 1-propenylene, 2-propenylene and butenylene groups; alkynylene groups, in particular C₂₋₄ alkynylene groups, such as acetylenylene and propargylene groups; arylene groups, in particular C₆₋₁₀ arylene groups, such as phenylene and naphthylene groups; methacryl or methacryloxy(C₁₋₁₀ alkyl) groups, such as a methacryloxypropyl group; epoxyalkyl or epoxyalkoxyalkyl groups in which the alkyl group is linear, branched or cyclic, and is a C₁₋₁₀ alkyl group, and the alkoxy group comprises from 1 to 10 carbon atoms, such as glycidyl and glycidyloxy(C₁₋₁₀ alkyl) groups. R′″ preferably represents a methylene group or a glycidyloxy(C₁₋₁₀ alkyl) group such as a glycidyloxypropyl group; and

L′ represents a preferably polydentate complexing ligand;

m′ represents the degree of hydroxylation of the ligand L′, with m′=1 when L′ is a monodentate ligand and m′=2 when L′ is a polydentate ligand.

In a preferred embodiment, the matrix is obtained from a mixture of at least three silicon alkoxides:

Si(OR¹)₄

R²Si(OR¹)₃ and

R³R⁴Si(OR¹)₂

in which:

R¹ represents a methyl or ethyl group;

R² and R³ each represent a (meth)acrylate, vinyl, epoxyalkyl or epoxyalkoxyalkyl group in which the alkyl group is linear, branched and/or cyclic, and is a C₁₋₁₀ alkyl group, and the alkoxy group comprises from 1 to 10 atoms, for example the 3,4-epoxycyclohexylethyl group or glycidyloxy(C₁₋₁₀ alkyl) group such as a glycidyloxypropyl group; and

R⁴ represents a C₁₋₁₀ alkyl group, such as a methyl group.

Preferably, the proportion of the R²Si(OR¹)₃ precursor is in the majority, whilst that of the R³R⁴Si(OR¹)₂ precursor is in the minority, for example from 5 to 30% by weight relative to the total weight of the mixture of precursors.

In one particular embodiment, the matrix may be prepared from three silicon alkoxides R³R⁴Si(OR¹)₂, R²Si(OR′)₃ and Si(OR¹)₄, for example in a respective proportion of 10%, 60% and 30% by weight relative to the total weight of the mixture of precursors.

The solvent is mainly composed of water. Preferably, it comprises 80 to 100% by weight of water relative to the total weight of the solvent, and optionally a C₁₋₄ alcohol, preferably ethanol or isopropanol.

The catalyst is preferably an acid, better still acetic acid, or CO₂.

The solution to be deposited may be predominantly composed of a mixture of silanes, for example from 5 to 30% by weight, preferably around 20% by weight relative to the total weight of the solution. The molar ratio of acid relative to the silicon is preferably around 1%. The molar ratios of the functionalized nano-building blocks added relative to the silicon are preferably less than 20%. For example, they are preferably 5% and 10% for the cerium oxide and the zirconium oxide respectively.

The nanostructured materials such as described above, may comprise, in addition, other functionalized or non-functionalized nano-building blocks, different from those defined above.

Another subject of the invention consists of a method for preparing nanostructured materials according to the invention.

The nanostructured materials according to the invention may be prepared according to a method comprising, in particular, the steps consisting in:

on the one hand
a) preparing the nano-building blocks by a hydrolytic or non-hydrolytic process from at least one metal alkoxide such as described above; and
b) functionalizing the nano-building blocks by means of a functionalizing agent, such as described above;
   optionally, on the other hand, in:
c) preparing the hybrid organic/inorganic matrix by a sol-gel process, from three silicon alkoxides such as defined above, the preparation by a sol-gel process being carried out in the presence of a solvent, and optionally a catalyst such as described above;
   then optionally in
d) mixing the functionalized nano-building blocks obtained in step b) and the matrix obtained in step c).

Preferably, in the functionalizing step b) are mixed the following ingredients in the order indicated below:
1) the nano-building blocks obtained in step a), dispersed in the solvent, preferably water,
2) an acid, preferably nitric acid, in order to adjust the pH of the suspension to an acid pH, for example of between 3 and 4, and
3) the mixture of at least two functionalizing agents, preferably added dropwise,
   then the suspension is kept stirring, preferably for at least 24 hours.

At least one additive such as described above may optionally be added during step a) or during step d) or during both of steps a) and d).

In the case where an additive is added during step a), it may form a final material from step d) of core/shell type, the core being formed from the additive and the shell being formed from of a nano-building block.

The additives which may be used in the invention are especially surfactants in order to improve the wettability of the sol on to the metallic substrate, such as the non-ionic fluoropolymers sold under the trade marks FC 4432 and FC 4430 by 3M; colorants, for example rhodamine, fluorescein, methylene blue and ethyl violet; crosslinking agents such as (3-trimethoxysilylpropyl)diethylenetriamine (DETA); coupling agents such as aminopropyltriethoxysilane (APTS); nanopigments; corrosion inhibitors such as benzotriazole; or mixtures thereof.

This method is carried out under conditions referred to as mild, that is to say at ambient temperature around 20 to 25° C. and at atmospheric pressure.

Another subject of the invention is an article comprising a metallic substrate, for example made of titanium, aluminium or one of their alloys, and at least one coating composed of at least one nanostructured material such as defined above.

Examples of metallic substrates used in order to be coated by the nanostructured material described above are titanium, aluminium and their respective alloys, such as for example TA6V titanium, aluminium from the 2000 family, more particularly plated or unplated Al 2024, aluminium from the 7000 family, more particularly Al 7075 or 7175 and aluminium from the 6000 or 5000 family.

The coatings of such metallic surfaces, obtained from nanostructured materials such as described above, make it possible, in particular, to obtain protection against corrosion, scratch resistance, colouring and hydrophobic character that can be adjusted at will, while adhering well to the surface of the metallic substrate.

Moreover, these coatings are deposited by using techniques that are simple to implement on metallic surfaces, for example by dipping in a bath, depositing on to the substrate by spin, spray or laminar-flow coating or depositing with a brush. Furthermore, these techniques use environmentally friendly products.

The article according to the invention may be prepared by a conventional coating method that comprises a step of dipping in a bath, depositing on to the substrate by spin, spray or laminar-flow coating or depositing using a brush, at least one nanostructured material such as defined above.

The invention and the advantages that it provides will be better understood thanks to the exemplary embodiments given below by way of indication.

### EXAMPLES

### Example 1

### Preparation of a Solution for Producing Nanoparticles from SiO₂/GPTMS/DMDES (NBB1)

10 g of a commercial suspension of silica nanoparticles (30 wt % colloidal silica in water, sold under the trade mark Ludox® by Sigma-Aldrich, average particle diameter=12 nm) were diluted with 50 g of demineralised water. The pH of the silica suspension was adjusted to 4 by addition of a solution of HNO₃ (1 mol/l (or M)). Next, a mixture of 30.3 g of 3-glycidoxypropyltrimethoxysilane (GPTMS) and 4 g of dimethyldiethoxysilane (DMDES) was added dropwise to the suspension. Then the whole mixture was left stirring at ambient temperature for 24 hours.

### Example 2

### Preparation of a Solution for Producing Nanoparticles from SiO₂—NH₂/GPTMS/DMDES (NBB2)

10 g of a commercial suspension of silica nanoparticles (30 wt % colloidal silica in water, sold under the trade mark Ludox® by Sigma-Aldrich, average particle diameter=12 nm) were dispersed in 60 g of demineralised water. The pH of the silica suspension was adjusted to 9 by addition of a (1M) HCl solution. 20% by weight of aminopropyltriethoxysilane, relative to the total weight of the mixture, was added. The suspension was kept stirring for 2 h at ambient temperature. The particles were isolated by filtration then they were washed with ethanol by centrifuging (3×20 min at 10,000 rpm) and finally dried at ambient temperature for 8 h.

3 g of NBB2 functionalised nanoparticles were dispersed in 60 g of demineralised water. The pH of the silica suspension was adjusted to 4 by addition of a solution of HNO₃ (1M). Next, a mixture of 30.3 g of GPTMS and 4 g of DMDES was added dropwise to the suspension. Then the whole mixture was left stirring at ambient temperature for 24 hours.

### Example 3

### Preparation of a Solution by Production of Nanoparticles from Al₂O₃/GPTMS/DMDES (NBB3)

3 g of Al₂O₃ nanoparticles (in powder form sold under the trade mark Meliorum Technologies, average particle diameter=10 nm) were dispersed in 50 g of demineralised water. The pH of the aluminium oxide suspension was adjusted to 4 by addition of a solution of HNO₃ (1M). Next, a mixture of 30.3 g of GPTMS and 4 g of DMDES was added dropwise to the suspension. Then the whole mixture was left stirring at ambient temperature for 24 hours.

### Example 4

### Preparation of a Solution for Producing Nanoparticles from ZrO₂/GPTMS/DMDES (NBB4)

30 g of a commercial suspension of zirconium oxide nanoparticles (10 wt % colloidal suspension in water, sold under the trade mark Pinnacle Zirconium Dioxide® by Applied Nanoworks, average particle diameter=3-5 nm) were dispersed in 20 g of demineralised water. Next, a mixture of 30.3 g of GPTMS and 4 g of DMDES were added dropwise to the suspension. Then the whole mixture was left stirring at ambient temperature for 24 hours.

### Example 5

### Preparation of a Solution for Producing Nanoparticles from SiO₂/GPTMS/DMDES+CeO₂—NH₂ (NBB5)

1.65 g of 6-aminocapric acid were added to 9.65 ml of a solution of cerium oxide nanoparticles sold by Rhodia (under the trade mark Rhodigard W200, pH=8.5) (carboxylate/Ce molar ratio=1). After 4 hours, 8 ml of this suspension was added to the solution of the NBB1 from Example 1.

### Example 6

### Preparation of a Solution for Producing Nanoparticles from SiO₂—NH₂/GPTMS/DMDES+CeO₂—NH₂ (NBB6)

The procedure from Example 5 was followed but replacing the solution of NBB1 by the solution of NBB2 from Example 2.

### Example 7

### Preparation of a Solution for Producing Nanoparticles from Al₂O₃/GPTMS/DMDES+CeO₂—NH₂ (NBB7)

The procedure from Example 5 was followed but replacing the solution of NBB1 by the solution of NBB3 from Example 3.

### Example 8

### Preparation of a Solution for Producing Nanoparticles from ZrO₂/GPTMS/DMDES+CeO₂—NH₂ (NBB8)

The procedure from Example 5 was followed but replacing the solution of NBB1 by the solution of NBB4 from Example 4.

### Example 9

### Preparation of a Solution for Producing Nanoparticles from SiO₂/GPTMS/DMDES+CeO₂—NH₂+ZrO₂

A tetrapropoxyzirconium (TPOZ)/CH₃COOH/H₂O mixture (9.75 g/5 g/3.75 g) was stirred for 30 minutes before being added to the solution obtained in Example 5.

### Example 10

### Preparation of a Solution for Producing Nanoparticles from SiO₂/GPTMS/DMDES+CeO₂—NH₂+ZrO₂+DETA+Colorant

6.63 g of a solution of crosslinking agent, (3-trimethoxy-silylpropyl)diethylenetriamine (DETA) of formula (OMe)₃Si(CH₂)₃NH(CH₂)₂NH(CH₂)₂NH₂, were added dropwise then the opaque solution was left overnight at ambient temperature with vigorous and regular stirring in order to become clear again. Finally, just before the deposition, 50 mg of a colorant, Rhodamine B, were added to the solution in an amount such that its concentration in the final solution was around 10⁻³M.

A substrate made of an unplated alloy Al 2024 T3 with dimensions of 125 mm×80 mm×1.6 mm to give a total surface area of 1 dm² just before the deposition, was prepared according to a methology known to a person skilled in the art such as alkaline degreasing followed by acid pickling.

The film was deposited on the substrate by dip coating for 2 minutes with a removal rate of 0.68 cm/s⁻¹, then it was dried in an oven for 1 hour at 110° C.

### Example 11

### Preparation of a Solution in View of Producing a TMOS/GPTMS/DMDES Matrix+ZrO₂+DETA+Colorant

Added dropwise, with stirring, at ambient temperature, to 65 ml of a 0.05M aqueous solution of acetic acid was the mixture of 9.3 g of tetramethoxysilane (TMOS), 37.4 g of 3-glycidoxypropyl-trimethoxysilane (GPTMS) and 4.9 g of dimethyldiethoxysilane (DMDES). This solution was kept stirring at ambient temperature for one day.

Next, a mixture composed of a 70% solution of tetrapropoxyzirconium (TPOZ) in propanol/CH₃COOH/H₂O in a weight ratio of 11.7 g/6 g/4.5 g, previously stirred for 30 minutes, was added. The final solution was stirred at ambient temperature for 30 minutes, then 7.96 g of (3-trimethoxysilylpropyl)diethylenetriamine were added dropwise as a crosslinking agent. The whole mixture was left for 15 hours at ambient temperature with vigorous and regular stirring. Next, 60 mg of rhodamine B were added in an amount such that its concentration in the final solution was around 10⁻³M.

A substrate was prepared just before the deposition in the same manner as in Example 10.

A film was deposited on the substrate by dip coating for 2 minutes with a removal rate of 0.68 cm/s⁻¹, then it was dried in an oven for 1 h at 110° C.

1. Nanostructured material comprising at least one nano-building block based on silica, alumina, zirconia, titanium oxide or cerium (IV) oxide, functionalized with at least two functionalizing agents of formula (1), (2) or (3):
Z₄₋ₓSi((R′)ₚ—F)ₓ (1)
Z_{4-x-y}(F′—(R′)ₚ)_{y}Si((R′)ₚ—F)ₓ (2)
Z_{n-ma-mb}(F′-L)ₘₐM(L-F)_{mb} (3)
in which:
each Z represents, independently of one another, a halogen atom or an —OR group;
R represents an alkyl, preferably C₁₋₄ alkyl, group;
x and y are integers ranging from 1 to 3 on condition that 4−x≧1 for the formula (1) and 4−x−y≧0 for the formula (2);
each R′ represents, independently of one another, an organic spacer group chosen from alkylene, preferably C₁₋₄ alkylene, groups, alkenylene, especially C₂₋₄ alkenylene, groups and C₆₋₁₀ arylene groups;
p is equal to 0 or 1;
each F is chosen from alkyl groups, especially C₁₋₄ alkyl groups, alkenyl groups, in particular C₂₋₄ alkenyl groups, alkynyl groups, in particular C₂₋₄ alkynyl groups, aryl groups, in particular C₆₋₁₀ aryl groups, methacryl or methacryloxy(C₁₋₁₀ alkyl) groups, epoxyalkyl or epoxyalkoxyalkyl groups in which the alkyl group is linear, branched or cyclic, and is a C₁₋₁₀ alkyl group, and the alkoxy group comprises from 1 to 10 carbon atoms, C₂₋₁₀ haloalkyl groups, C₂₋₁₀ perhaloalkyl groups, C₂₋₁₀ mercaptoalkyl groups, C₂₋₁₀ aminoalkyl groups, amino(C₂₋₁₀ alkyl)amino(C₂₋₁₀ alkyl) groups, di(C₂₋₁₀ alkylene)triamino(C₂₋₁₀ alkyl) groups and imidazolyl(C₂₋₁₀ alkyl) groups;
each F′ and L are, each one, a monodentate or polydentate complexing ligand, preferably a polydentate complexing ligand;
M represents Al(III), Ce(III), Ce(IV), Zr(IV), Ti(IV), Sn(IV), Nb(V), V(V), Ta(V), Hf(V), or a rare earth such as Y(III), La(III) and Eu(III), the number between brackets being the valency of the M atom;
n represents the coordination state of the M atom;
m represents the number of coordination bonds between the chelating agent L and the metal M;
a and b are integers such that ma+mb≦n.

2. Nanostructured material according to claim 1, characterized in that M represents Al(III), Ce(III), Ce(IV), Zr(IV) or Ti(IV).

3. Nanostructured material according to claim 1 or 2, characterized in that:
R represents a methyl or ethyl group;
R′ represents an organic spacer group chosen from methylene, ethylene, propylene, butylene, vinylene, 1-propenylene, butenylene, phenylene and naphthylene groups;
F represents a non-hydrolysable group chosen from methyl, ethyl, propyl, butyl, vinyl, 1-propenyl, 2-propenyl, butenyl, acetylenyl, propargyl, phenyl, naphthyl, methacryl, methacryloxypropyl, glycidyl, glycidyloxy(C₁₋₁₀ alkyl), chloropropyl, perfluoropropyl, mercaptopropyl, 3-aminopropyl, 3-[(2-aminoethyl)amino]propyl and 3-[diethylenetriamino]propyl groups; and
F′ and L are chosen from carboxylic acids, β-diketones, β-keto esters, α- and β-hydroxy acids, amino acids, a polyamine, phosphonic acid and phosphonates.

4. Nanostructured material according to any one of the preceding claims, characterized in that the nanoblock is in cluster form or in the form of nanoparticles.

5. Nanostructured material according to claim 4, characterized in that the nanoparticles have a size ranging from 2 to 100 nm.

6. Nanostructured material according to claim 5, characterized in that the nanoparticles have a size ranging from 2 to 50 nm.

7. Nanostructured material according to any one of the preceding claims, characterized in that the nano-building block or blocks are synthesized from metal salts, by precipitation.

8. Nanostructured material according to any one of claims 1 to 6, characterized in that the nano-building blocks are obtained from at least one alkoxide or halide of silicon, aluminium, zirconium, titanium or cerium (IV), via a hydrolytic or non-hydrolytic process.

9. Nanostructured material according to claim 8, characterized in that said alkoxide or halide used in a hydrolytic process corresponds to one of the following formulae:
M₁(Z₁)ₙ₁ (4),
(R₁′)ₓ₁M₁(Z₁)ₙ₁₋ₓ₁ (5),
(L₁^{m1})ₓ₁M₁(Z₁)ₙ₁₋ₘ₁ₓ₁ (6), or
(R₁O)₃Si—R₂—Si(OR₁)₃ (7),
formulae (4), (5), (6) and (7) in which:
M₁ represents Al(III), Ce(IV), Si(IV), Zr(IV) or Ti(IV), the number between brackets being the valency of the M₁ atom;
n₁ represents the valency of the M₁ atom;
x₁ is an integer ranging from 1 to n₁−1;
Z₁ represents a halogen atom or —OR₁;
R₁ represents an alkyl group, preferably comprising 1 to 4 carbon atoms;
R₁′ represents a non-hydrolysable group chosen from alkyl groups, especially C₁₋₄ alkyl groups, alkenyl groups, in particular C₂₋₄ alkenyl groups, alkynyl groups, in particular C₂₋₄ alkynyl groups, aryl groups, in particular C₆₋₁₀ aryl groups, methacryl or methacryloxy(C₁₋₁₀ alkyl) groups, epoxyalkyl or epoxyalkoxyalkyl groups in which the alkyl group is linear, branched or cyclic, and is a C₁₋₁₀ alkyl group, and the alkoxy group comprises from 1 to 10 carbon atoms;
L₁ is a monodentate or polydentate complexing ligand, preferably a polydentate complexing ligand;
m₁ represents the degree of hydroxylation of the ligand L₁; and
R₂ represents a divalent non-hydrolysable group chosen from alkylene groups, preferably C₁₋₄ alkylene groups, alkenylene groups, in particular C₂₋₄ alkenylene groups, alkynylene groups, in particular C₂₋₄ alkynylene groups, arylene groups, in particular C₆₋₁₀ arylene groups, methacryl and methacryloxy(C₁₋₁₀ alkyl) groups, epoxyalkyl or epoxyalkoxyalkyl groups in which the alkyl group is linear, branched or cyclic, and is a C₁₋₁₀ alkyl group, and the alkoxy group comprises from 1 to 10 carbon atoms.

10. Nanostructured material according to claim 9, characterized in that R₁ represents a methyl or ethyl group; R₁′ represents a non-hydrolysable group chosen from methyl, ethyl, propyl, butyl, vinyl, 1-propenyl, 2-propenyl, butenyl, acetylenyl, propargyl, phenyl, naphthyl, methacryl, methacryloxypropyl, glycidyl and glycidyloxy(C₁₋₁₀ alkyl) groups; and L₁ is a complexing ligand chosen from carboxylic acids, β-diketones, β-keto esters, α- and β-hydroxy acids, amino acids, phosphonic acid and phosphonates.

11. Nanostructured material according to any one of the preceding claims, comprising, in addition, a polymer or hybrid organic/inorganic matrix.

12. Nanostructured material according to claim 11, characterized in that the matrix is a hybrid organic/inorganic matrix obtained by polycondensation or at least one metal alkoxide or metal halide in the presence of a solvent, and optionally a catalyst.

13. Nanostructured material according to claim 12, characterized in that the metal alkoxide or metal halide has the general formula:
M′Z′_{n′} (8)
R″_{x′}M′Z′_{n′-x′} (9)
L′_{m′x′}M′Z′_{m′x′} (10)
Z′_{n′-1}M′-R′″-M Z′_{n′-1} (11)
in which:
n′ represents the valency of the M′ metal atom, preferably 3, 4 or 5;
x′ is an integer ranging from 1 to n′−1;
M′ represents a metal atom of valency III such as Al, of valency IV such as Si, Ce, Zr and Ti, or of valency V such as Nb;
Z′ represents a hydrolysable group chosen from halogen atoms, alkoxy groups, preferably C₁₋₄ alkoxy groups, aryloxy groups, in particular C₆₋₁₀ aryloxy groups, acyloxy groups, in particular C₁₋₄ acyloxy groups, and C₁₋₁₀ alkylcarbonyl groups;
R″ represents a monovalent non-hydrolysable group chosen from alkyl groups, preferably C₁₋₄ alkyl groups, alkenyl groups, in particular C₂₋₄ alkenyl groups, alkynyl groups, in particular C₂₋₄ alkynyl groups, aryl groups, in particular C₆₋₁₀ aryl groups, (meth)acryl or methacryloxy(C₁₋₁₀ alkyl) groups, and epoxyalkyl or epoxyalkoxyalkyl groups in which the alkyl group is linear, branched or cyclic, and is a C₁₋₁₀ alkyl group, and the alkoxy group comprises from 1 to 10 carbon atoms;
R′″ represents a divalent non-hydrolysable group chosen from alkylene groups, preferably C₁₋₄ alkylene groups, alkenylene groups, in particular C₂₋₄ alkenylene groups, alkynylene groups, in particular C₂₋₄ alkynylene groups, arylene groups, in particular C₆₋₁₀ arylene groups, methacryl or methacryloxy(C₁₋₁₀ alkyl) groups, and epoxyalkyl or epoxyalkoxyalkyl groups in which the alkyl group is linear, branched or cyclic, and is a C₁₋₁₀ alkyl group, and the alkoxy group comprises from 1 to 10 carbon atoms; and
L′ represents a preferably polydentate complexing ligand;
m′ represents the degree of hydroxylation of the ligand L′.

14. Nanostructured material according to claim 13, characterized in that:
n′ is equal to 4;
x′ is an integer ranging from 1 to 3;
M′ represents a silicon, cerium or zirconium atom;
Z′ represents a hydrolysable group chosen from Cl and Br, and methoxy, ethoxy, n-propoxy, i-propoxy, butoxy, phenoxy, acetoxy, propionyloxy and acetyl groups;
R″ represents a monovalent non-hydrolysable group chosen from methyl, ethyl, propyl, butyl, vinyl, 1-propenyl, 2-propenyl, butenyl, acetylenyl, propargyl, phenyl, naphthyl, methacryl, methacryloxypropyl, glycidyl and glycidyloxy(C₁₋₁₀ alkyl) groups;
R′″ represents a divalent non-hydrolysable group chosen from methylene, ethylene, propylene, butylene, vinylene, 1-propenylene, 2-propenylene, butenylene, acetylenylene, propargylene, phenylene, naphthylene, methacryl, methacryloxypropyl, glycidyl and glycidyloxy(C₁₋₁₀ alkyl) groups; and
L′ represents a carboxylic acid, a β-diketone, a β-keto ester, an α- or β-hydroxy acid, an amino acid, phosphonic acid or a phosphonate.

15. Nanostructured material according to any one of claims 12 to 14, characterized in that the solvent is mainly composed of water.

16. Nanostructured material according to claim 15, characterized in that the solvent comprises 80 to 100% by weight of water relative to the total weight of the solvent, and optionally a C₁₋₄ alcohol.

17. Nanostructured material according to any one of claims 12 to 16, characterized in that the catalyst is an acid, preferably acetic acid, or CO₂.

18. Nanostructured material according to any one of the preceding claims, comprising, in addition, at least one functionalized nano-building block different from that defined in claim 1, or non-functionalized nano-building block.

19. Method for preparing a nanostructured material according to any one of claims 1 to 10, comprising the steps consisting in:
(a) preparing the nano-building blocks by a hydrolytic or non-hydrolytic process from at least one metal alkoxide or metal halide such as defined in claims 9 and 10; and
(b) functionalizing the nano-building blocks by means of a functionalizing agent, such as defined in claim 1.

20. Method for preparing a nanostructured material according to any one of claims 11 to 17, comprising, on the one hand, the method according to claim 19, and, on the other hand, the steps consisting in:
(c) preparing the hybrid organic/inorganic matrix by a sol-gel process, from at least one metal alkoxide such as defined in claim 13 or 14, the preparation by a sol-gel process being carried out in the presence of a solvent, and optionally a catalyst; then in
(d) mixing the functionalized nano-building blocks obtained in step b) and the matrix obtained in step c).

21. Preparation method according to claim 19 or 20, characterized in that at least one additive is added during step a) or during step d) or during both steps a) and d).

22. Preparation method according to claim 21, characterized in that an additive is added during step a) and that the final material from step d) is of the core/shell type, the core being formed from the additive and the shell being formed from a nano-building block.

23. Preparation method according to claim 21 or 22, characterized in that the additive is chosen from surfactants in order to improve the wettability of the sol on to the metallic substrate, colorants, crosslinking agents, coupling agents, corrosion inhibitors and mixtures thereof.

24. Use of the nanostructured material according to any one of claims 1 to 18, in aeronautics and the aerospace industry, as a protective coating for metallic surfaces.

25. Article characterized in that it comprises a metallic substrate and at least one coating composed of at least one nanostructured material according to any one of claims 1 to 18.

26. Article according to claim 25, characterized in that the metallic substrate is made of titanium, aluminium or one of their alloys.

27. Method for preparing an article according to claim 25 or 26, characterized in that it comprises a step of dipping in a bath, depositing on to the substrate by spin, spray or laminar-flow coating or depositing using a brush, at least one nanostructured material according to any one of claims 1 to 18.
